(19) United States
(12) Patent Application Publication
(10) Pub. No.: US 2005/0225914 A1
(43) Pub. Date: Oct. 13, 2005

(54) Power supply

(76) Inventor: Steve King, Berkshire (GB)

Correspondence Address: DUANE MORRIS, LLP;IP DEPARTMENT, ONE LIBERTY PLACE, PHILADELPHIA, PA, 19103-7396, US

(21) Appl. No.: 10/522,691

(22) PCT Filed: Feb. 28, 2003
(86) PCT No.: PCT/GB03/00839

§ 371 Date: Apr. 18, 2005

(30) Foreign Application Priority Data
Jul. 31, 2002 (GB) 0217767.3

(51) Int. Cl. H02H 3/00

(52) U.S. Cl. 361/62

(57) ABSTRACT

An uninterruptible power supply device for supplying electrical energy to one of an array of loads having a broad range of power requirements, the uninterruptible power supply device including: at least one power means for providing electrical energy for the said one load; and control means, connected to the or each power means and the load; wherein: the or each power means incorporates a plurality of electrical potential energy storage units; and the control means is arranged to connect the electrical potential energy storage units according to the power required by the load, the same power means being employable for each one of the array of loads.

The present invention concerns improvements in or relating to power supply and provides, more specifically, an uninterruptible power supply for supplying electrical energy to a load, particularly though not exclusively, to one of an array of loads in an environment, such as a hospital, where the loads have a broad range of power requirements.

The harnessing of electrical energy, that is energy provided by flowing charge, has radically transformed modern day life from all but fifty years ago. The development of extensive supply networks has allowed electricity to infiltrate many aspects of modern day life, with most industrial and domestic activities utilising this type of energy in some way. Electricity is distributed geographically using so-called “step-up, step-down” voltage adjustment techniques. Alternating currents generated by power stations are transmitted to local distribution companies along high-voltage transmission cables, the high voltages helping to minimise energy losses during transmission. The distribution companies then “step” the electric currents “down” to lower voltages as required by local domestic and industrial devices, providing what is referred to as a mains/utility power supply.

Connecting an electrical device or “load” to a power supply causes electrons to flow into and be driven through the device. The voltage of the power supply sets up a potential difference across the load, creating an electric field through which the electrons are accelerated, whilst the resistance of the load determines how much current is drawn from the power supply; The power supplied to and used by the device is defined as the energy lost from the electrons to the device per second, the electrons losing energy as a result of undergoing collisions with ions or atoms. Hence, the power is determined by both the voltage of the power supply and the resistance of the load.

An ongoing supply of electricity to certain devices can be critical, with failure of the supply having devastating effects. For example, an electricity cut in a hospital would terminate life support, lighting and heating systems unless the necessary back-up systems were in place. In commerce, where computers are now used to carry out the majority of office-based tasks, many businesses would simply grind to a halt during a power outage and crucial data may be damaged or irretrievably lost. Clearly, the cost of disruptions to power supplies, both in human safety and financial terms, can be severe.

There can be many different causes of disruption to the mains electricity supply. For example, high-voltage transmission cables can get damaged by severe weather conditions thereby preventing electricity from reaching a local distribution company, or antiquated wiring systems in an old building could become overloaded and fail so that electricity is unable to reach the building's power supply outlets. In addition, even when the supply of electricity is ceaseless, the electric current it provides can be subject to deviations. Spikes, surges and brownouts (periods where the electricity level is appreciably reduced for a sustained period of time), or oscillation anomalies are all common occurrences within the mains supply which critical loads must be protected against, particularly since damage resulting from such fluctuations may not be immediately discernible.

Uninterruptible power supply (UPS) devices have been developed to shield data and equipment from power-related damage and failure. They are connected between electrical equipment and the main power supply (which is not necessarily the mains/utility supply) and, in the advent of the main supply failing, provide a temporary back-up source of electricity and alert system operators to the power supply problem. Typically a UPS keeps electrical equipment running for several minutes after a power outage, providing time in which to effect a smooth transition to electricity from emergency generators or to save data and shut down equipment safely.

There are three main types of uninterruptible power supply device: off-line, line-interactive and on-line. All three types use batteries as the source of the back-up electric current that they supply. During normal operation of the main power supply, some or all of the electricity is routed through the UPS, keeping its battery fully charged. However, alternating current must be rectified to direct current before it can be used to charge the battery and, thereafter, current drawn from the battery by an external load must be inverted back to alternating current if this is the type of current which the device is expecting. Accordingly, uninterruptible power supplies are generally comprised of a rectifier, a battery and an inverter.

Off-line uninterruptible power supplies remain inactive unless required They split current from the main power supply into two branches, one of which feeds the load whilst the other keeps the back-up battery fully charged. A microprocessor constantly monitors the output of the main power supply and effects a switch to the battery whenever the main supply dips to the point of creating an outage. This transition typically takes place within 4 to 20 milliseconds of the outage being detected. Accordingly, off-line UPS devices only protect against power cuts and they are generally only used to shield non-networked personal computers.

Line-interactive UPS devices are similar to off-line ones, except that operation of the main power supply is restricted to within predefined current limits. If the current strays outside of the accepted tolerance range, through either sags or spikes in the main power supply, then a switch is made to the battery. Hence, line-interactive devices offer improved protection over the off-line models, but a switch-over time is still incurred.

On-line UPS devices provide the highest level of protection for electrical equipment. During normal operation all of the electric current from the main power supply is routed through the back-up battery, so that a very “clean” current is always provided to the load. When a power outage occurs the load continues to draw current from the battery, allowing the transition to generator power or shut-down to be performed safely; this eliminates the switch-over time of the other two models. Accordingly, on-line UPS devices, which are the focus of the invention that will presently be described, tend to be used in mission critical applications such as life support machines and computer server rooms.

Uninterruptible power supplies are needed to support both electrical devices which operate in isolation from other devices and those which form part of a larger interconnected framework. A machine on a hospital ward or a non-networked personal computer are examples of isolated pieces of equipment, whilst an office's computing network is an example of an extended system. In both cases, as a matter of good practice, the uninterruptible power supply is provided as a device distinct from the equipment it supports. When used in conjunction with a non-networked personal computer, a UPS will usually be stationed underneath the desk on which the computer stands. In contrast, when personal computers are spread throughout a large networked office, a UPS will be installed in a dedicated communications room. This room will house the servers for the network in specially designed metal cabinets, or so-called “racks”, which also have the capacity to store UPS units.

Most of the UPS manufacturing industry has been polarised into producing separate “standalone” and “rack-mount” units. Standalone UPS devices need to take up as little floor space as possible, whilst in a rack a UPS unit has to slot into a holding bay of standard width (19 inches). However, a large portion of the market utilises both types of UPS device. For example, on a hospital ward a standalone UPS will be stationed in close proximity to the equipment it supports, whilst the UPS devices which back-up the hospital's communications room may be mounted on a wire rack along with servers. Having to order and maintain different types of UPS device introduces unnecessary risk into critical back-up systems, as well as placing an increased burden on inventory and budget. Accordingly, there is a need for uninterruptible power supplies to be dual-format—that is suitable for both standalone and rack-mount use.

As stated above, the majority of manufacturers have not responded to this need within the market as a whole, but even those that do produce dual-format devices have failed to provide UPS units which are readily interchangeable. The orientation of a dual-format UPS device is usually switched when changing from one mode to the other, with a vertical orientation being preferred for the standalone mode (so as to minimise floor area occupied by the device) and a horizontal orientation being used when mounting the device in a standard “19 inch” rack. However, in addition to changing orientation, the UPS devices presently on the market all require some form of mechanical intervention before they can be used in the other format; for example, sometimes panelling has to be removed and replaced with a different part. In addition, the output display on a UPS device does not readily translate from one mode to the other, with many manufacturers simply relying on the ability of their customers to read signal outputs sideways! This would certainly seem to be ill-advised, given the critical nature of the loads involved. One known improvement has been to use light-emitting diode (LED) displays, so that the orientation of the signal outputs can be changed with the orientation of the UPS device. Separate display masks are provided for the vertical and horizontal orientations so that the user may quickly identify the different output signals, but this involves the user removing the front display panel in order to position the mask and relies on their not misplacing the mask which is not in use. In summary, changing between modes of dual-format UPS devices is at present unduly cumbersome and, in some instances, can make the device difficult to use.

In addition to the above, dual-format devices have only been available thus far for equipment with power requirements ranging up to 3000 VA. Critical equipment which operates in the 4000 VA to 6000 VA range has had to be supported by standalone UPS units, primarily because of the battery weight involved. The power supplied to a load can, of course, be increased either by providing more electric current or increasing the voltage across the load. More current can be made available from a UPS simply by connecting in further batteries of the same voltage in parallel, but this also leads to increased power losses through the conductors and reduces efficiency. Historically, loads with higher power requirements have therefore been backed-up by UPS devices containing batteries of higher voltages, but with the disadvantage that batteries become heavier as their voltage increases. UPS devices for equipment operating in the 4000 VA to 6000 VA range weigh hundreds of kilograms and are difficult to manoeuvre and install. They are not suitable for use in a racking environment, and as a result it is sometimes necessary to clutter a communications room with standalone UPS devices for high-powered equipment.

Inventory is again increased if a business or organisation requires UPS devices for equipment operating across a broad power range, since different batteries must be ordered, stocked and fitted for every UPS model. At present, up to five different models of UPS devices would be needed to support critical load equipment which operates across the 700 VA to 6000 VA power range. For a large organisation (such as the National Health Service in the UK) which is spread across many different sites, and where UPS devices are widely distributed within each site, the stock control and maintenance issues presented by the different battery types are considerable. The different battery requirements of each UPS model also introduce a further level of possible confusion for users, many of whom are not experts in maintaining electrical systems; fitting the wrong type of battery in a UPS device could have fatal consequences when the UPS device is called upon to deliver power in due course.

It is desired to overcome or substantially reduce some of the above mentioned problems. More specifically, it is desired to provide an uninterruptible power supply device, for supplying electrical energy to one of an array of loads having a broad range of power requirements, which employs substantially identical batteries irrespective of the size of the load. In addition, it is desired to provide improved safety and maintenance provisions for any uninterruptible power supply device. It is also desired to provide an uninterruptible power supply device which is readily interchangeable between rack-mount and standalone formats.

According to one aspect of the invention there is provided an uninterruptible power supply device for supplying electrical energy to one of an array of loads having a broad range of power requirements, and for continuing to supply electrical energy to the said one load for a limited period of time in the event of failure of the said one load's main power supply, the uninterruptible power supply device including: at least one power means for providing electrical energy for the said one load; and control means, connected to the or each power means and the load, for controlling the device; wherein: the or each power means incorporates a plurality of electrical potential energy storage units, each storage unit providing substantially the same electrical potential energy as determined by a potential difference, or a voltage, across the electrical potential energy storage unit; and the control means is arranged to connect the electrical potential energy storage units according to the power required by the load, the same power means being employable for each one of the array of loads.

Having a power means which can be employed within the uninterruptible power supply device of the present invention, irrespective of which one of the array of loads the device supports, provides great benefits in terms of safety and cost. Stock control is greatly simplified, in that only one type of power means need be ordered and stored for loads having very different power requirements. In a very large organisation, such as a national health service, the cost implications of this will be significant, since the stock order is simplified and the interchangability, or “hot-swap” nature, of the power means allows the stock float to be reduced. In addition, the possibility of the wrong type of power means being connected to the uninterruptible power supply device is eliminated, resulting in a system which is more safely maintainable.

More particularly, a voltage across the control means is determined by the voltage across the or each power means and the uninterruptible power supply device is arranged to provide electrical energy to a different one of the array of loads by altering the voltage across the control means.

Hence, by using different combinations and arrangements of the power means, different models of the uninterruptible power supply device can be configured to provide different operating voltages and, hence, supply different powered loads. In particular, it is preferred that any connection made by the control means between electrical potential energy storage units, or between power means, is made within the control means, in order that an operator can make the necessary connections without being electronically skilled. Accordingly, an operator using an uninterruptible power supply device further including at least one connecting cable for respectively connecting the control means to the or each power means, need only use one type of cable in effecting the connections within the control means to provide the power required by the load. The operator's task in this regard can be further simplified by providing a connecting cable which is connectable to the control means only in a preferred orientation.

It is particularly advantageous if each power means weighs no more than 25 kg, which is deemed to be the maximum weight that a single person can comfortably lift by health and safety regulations. If the control means also weighs 25 kg or less, then the installation and maintenance of the uninterruptible power supply device can be performed by a single person, as opposed to the two or three persons required in these regards for uninterruptible power supply devices of the prior art.

According to another aspect of the present invention there is provided an uninterruptible power supply device for supplying electrical energy to a load, and for continuing to supply electrical energy to the load for a limited period of time in the event of failure of the load's main power supply, the uninterruptible power supply device including: at least one power means for providing electrical energy for the load; and control means, connected to the power means and the load, for controlling the device; wherein the control means is arranged to connect to a further power supply in the event of failure of the load's main power supply, such that the or each power means remains substantially unchanged during normal operation of the uninterruptible power supply device.

This aspect of the present invention provides the critical load with another defence prior to enforced shutdown and helps to keep the load operational for longer. It is particularly advantageous for industrial, rather than domestic, electricity users who can be provided with separately generated single-phase alternating currents from the mains supply which can be employed as the main and further power supplies of the critical load mentioned above.

According to a further aspect of the present invention there is provided an uninterruptible power supply device for supplying electrical energy to a load, and for continuing to supply electrical energy to the load for a limited period of time in the event of failure of the load's main power supply, the uninterruptible power supply device including: at least one power means for providing electrical energy for the load; and control means, connected to the power means and the load, for controlling the device; wherein: the control means is provided with, and controls, an internal bypass switch which, when closed, causes the electrical energy as supplied by the load's main power supply to be provided directly to the load; the internal bypass switch is also manually operable by an operator of the uninterruptible power supply device; and the uninterruptible power supply device is connectable to a bypass means, the bypass means being arranged to isolate the uninterruptible power supply device from the load after the internal bypass switch has been closed.

By requiring an operator of the uninterruptible power supply device to first cause an internal bypass within the uninterruptible power supply device, before engaging an external bypass of the uninterruptible power supply device, this aspect of the present invention ensures that any current anomalies within the mains power supply do not act against the device's inverter. In addition, the uninterruptible power supply device can be completely isolated from the load, allowing maintenance to be performed on either the control means or power means when the uninterruptible power supply device is remote from the load.

According to a still further aspect of the present invention there is provided an uninterruptible power supply device for supplying electrical energy to a load, and for continuing to supply electrical energy to the load for a limited period of time in the event of failure of the load's main power supply, the uninterruptible power supply device including: at least one power means for providing electrical energy for the load; and control means, connected to the power means and the load, for controlling the device; wherein the control means incorporates a display unit, housed within a receptacle, which is able to adopt a variety of positions within the receptacle.

When transferring between standalone and rack-mount formats in a dual-format uninterruptible power supply device, consideration must also be given to the orientation of the display unit which is to be read by an operator. Here, the variety of positions which can be adopted within the receptacle is advantageous because the operator is able separately to configure the display unit according to the orientation of the device. It is presently preferred that the display unit takes substantially the shape of a cube which is readily removable from, and reinsertable into, the receptacle, such that an operator is only required to make a manual adjustment to the device rather than a mechanical intervention.

According to a final aspect of the present invention there is provided an uninterruptible power supply device for supplying electrical energy to a load, and for continuing to supply electrical energy to the load for a limited period of time in the event of failure of the load's main power supply, wherein the uninterruptible power supply device is configurable into both rack-mount and standalone formats and is formed from a plurality of modular units; and the modular units are connectable together by bridging indentations of a first size which are formed between the modular units when positioned together in either rack-mount or standalone format.

Making the modular units connectable to one another is advantageous because in the standalone format it provides the uninterruptible power supply device with increased stability, whilst in both formats it provides an added level of security which prevents a critical part of the uninterruptible power supply device from being removed by mistake and endangering the load.

It is also preferable that two oppositely facing panels of each modular unit feature two oppositely facing indentations of a second size at the top and bottom of the panel, the indentations of the second size being substantially half the size of the indentations of the first size and being dual-purpose, being also suitable for use as a receptacle for a foot support to stabilise a modular unit when used in the standalone format.

### BRIEF DESCRIPTION OF THE DRAWINGS

Methods and apparatus according to preferred embodiments of the invention for providing a range of uninterruptible power supply devices which operate using substantially identical battery packs will now be described by way of example, with reference to the accompanying drawings in which:

FIG. 1 is a schematic block diagram showing an uninterruptible power supply connected in between a load which it supports and a mains electricity supply, according to a first embodiment of the invention;

FIG. 2 is a schematic block diagram showing a control module as featured in the uninterruptible power supply of FIG. 1, according to the first embodiment of the invention;

FIG. 3 is a schematic representation of a battery module, comprised of two battery packs, as featured in the uninterruptible power supply of FIG. 1, according to presently described embodiments of the invention;

FIG. 4a is a schematic representation of a battery configuration module, as featured in the control module of FIG. 2, when configured for connecting the battery packs of a battery module in series, according to presently described embodiments of the invention;

FIG. 4b is a schematic representation of the battery configuration module, as featured in the control module of FIG. 2, when configured for connecting the battery packs of a battery module in parallel, according to presently described embodiments of the invention;

FIG. 4c is a schematic representation of two battery configuration modules, as featured in FIG. 4b, connected in series, according to presently described embodiments of the invention;

FIG. 5 is a schematic representation of two battery configuration modules, as featured in FIG. 4b, when connected in parallel, according to presently described embodiments of the invention;

FIG. 6a is a schematic block diagram showing an uninterruptible power supply connected in between a load which it supports and a mains electricity supply, according to a second embodiment of the invention;

FIG. 6b is a schematic block diagram showing a control module as featured in the uninterruptible power supply of FIG. 6b, according to the second embodiment of the invention;

FIG. 7a is a perspective view of an uninterruptible power supply in a rack-mount configuration, according to embodiments of the present invention;

FIG. 7b is a perspective view of an uninterruptible power supply in a standalone configuration, according to the second embodiment of the present invention;

FIG. 8 is a partial perspective view of a front panel of an uninterruptible power supply with a disengaged display and input unit, according to embodiments of the present invention;

FIG. 9a is a schematic block diagram showing an uninterruptible power supply connected in between a load which it supports and a dual-feed mains electricity supply, according to a third embodiment of the invention;

FIG. 9b is a schematic block diagram showing a control module as featured in the uninterruptible power supply of FIG. 9a, according to the third embodiment of the invention; and

FIG. 10 is a schematic block diagram showing an uninterruptible power supply maintenance system, according to a fourth embodiment of the present invention.

### DETAILED DESCRIPTION OF PREFERRED EMBODIMENTS OF THE PRESENT INVENTION

In what follows, an on-line uninterruptible power supply device for supplying electrical energy to one of an array of loads having a broad range of power requirements will be described. A control means within the uninterruptible power supply device facilitates the supply of electrical energy to a load from one or more electrical potential energy storage units, the configuration of the control means and the number of electrical potential energy storage units being dependent on the power utilised by the load. A plurality of the electrical potential energy storage units is provided as a power means. Different loads having different power requirements are supported by different models of the uninterruptible power supply device, with each model employing a different control means. However, under the present invention, substantially identical electrical potential energy storage units are utilised by all of these models.

In each of the following embodiments the load's main power supply is taken to be the mains/utility electricity supply, whilst the control means is provided by a control module, each electrical potential energy storage unit is provided by a battery pack and each power means is provided by a battery module. In the first embodiment of the present invention, the different models of the uninterruptible power supply device supply loads having power requirements up to 6000 VA and for every model the battery packs are provided in pairs, distinct from the control module. Under the second embodiment a single battery pack is incorporated into the control module of those models which supply loads up to 2000 VA. In the third embodiment of the present invention the uninterruptible power supply device is arranged to incorporate a dual-feed mains electricity supply, thereby ensuring that the one or more battery packs within the uninterruptible power supply device only gradually become depleted in the event of complete mains failure. The fourth embodiment of the present invention provides the uninterruptible power supply device with additional by-pass means, provided by a by-pass module, which enables maintenance to be performed on the device without disrupting the supply of electrical energy to the load.

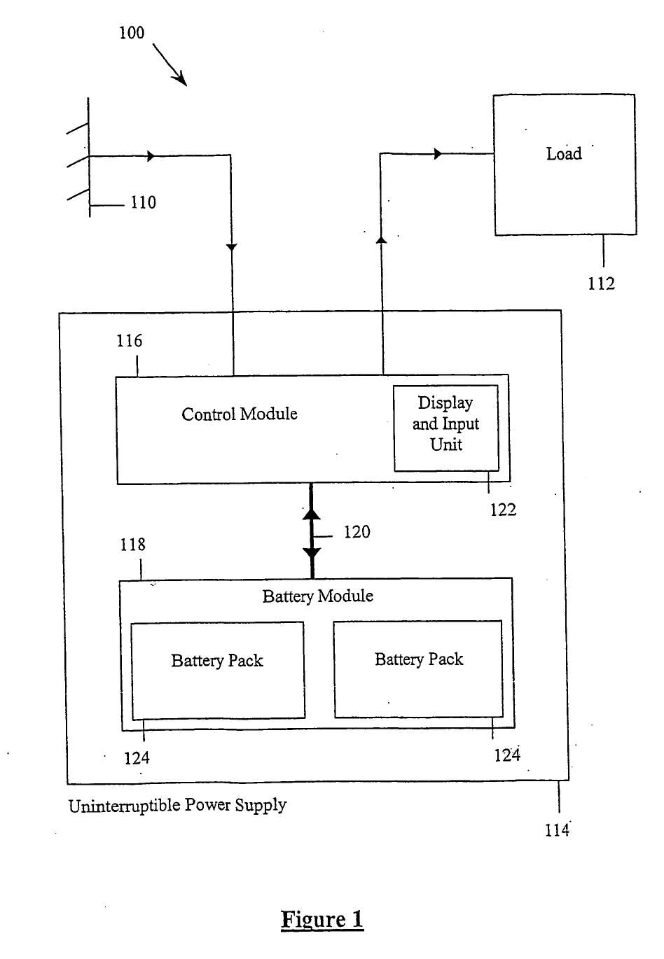

With reference to FIG. 1, a single-feed power supply system 100 for implementing the first embodiment of the present invention is now described. The single-feed power supply system 100 is comprised of a mains electricity supply 110, a critical load 112 and an uninterruptible power supply device 114. The uninterruptible power supply device 114 is of the ‘on-line’ variety described earlier and is hence connected between the mains electricity supply 110 and the load 112. Electricity from the mains supply 110 is passed through the uninterruptible power supply device 114 before being delivered to the load 112, so that the load 112 receives ‘clean’ electric current.

The uninterruptible power supply device 114 is comprised of a control module 116 and a battery module 118, which are connected via a connecting cable 120. The control module 116 oversees the operation of the uninterruptible power supply device 114, monitoring the electricity received from the mains supply 110 and protecting the load 112 from power-related damage. It houses a display and input unit 122, to which it outputs data regarding the mains electricity supply 110, and it provides an interface for an operator of the uninterruptible power supply device to control the device manually. In addition, the control module may optionally be connected to a computer system (not shown), allowing data messages to be sent to remote operators of the single-feed power supply system 100. The control module 116 also determines the connections which are made between two substantially identical battery packs 124 which are housed within the battery module 118. The weights of the control module 116 and the battery module 118 are limited to 25 kg, which is the maximum weight health and safety regulations deem it is safe for one person to lift.

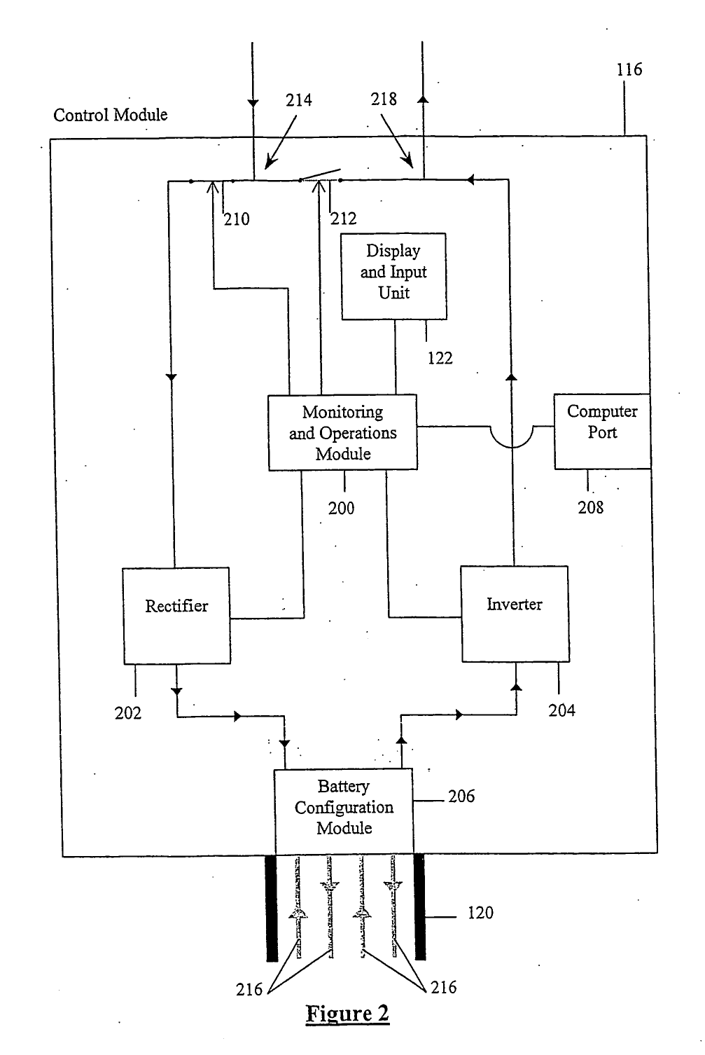

The control module 116 shown in FIG. 1 will now be described in more detail with reference to FIG. 2. In addition to the display and input unit 122, the control module 116 comprises: a monitoring and operations module 200; a rectifier 202 and an inverter 204; a battery configuration module 206; and a computer port 208. The monitoring and operations module 200 oversees the functionality of the control module 116 and is connected to the rectifier 202 and inverter 204, the display and input unit 122 and the computer port 208, such that it can both send and receive operational data to and from each of these parts of the control module 116. The computer port 208 is optionally used for connecting the control module 116 to a computer system, as mentioned above. The monitoring and operations module 200 is also connected to, and controls, two switches within the control module 116, namely a feed switch 210 and an internal bypass switch 212.

Current supplied from the mains electricity supply 110 to the control module 116 flows around the following electrical circuit. The mains electricity supply 110 is connected, within the control module 116, to an input current junction 214, on either side of which are connected the feed switch 210 and the internal bypass switch 212. The feed switch 210 connects to the rectifier 202, which effects conversion from alternating current to direct current and is, in turn, connected to the battery configuration module 206. The battery configuration module 206 receives the connecting cable 120, which connects to the external battery module 118 by means of four internal connecting wires 216; it also connects to the inverter 204 which converts ‘clean’ direct current received from the battery module 118 into alternating current as required by the load 112. The inverter 204 connects to an exit current junction 218, on either side of which are connected the internal bypass switch 212 and the output from the control module 116. Hence, the internal bypass switch 212 is located in between the input from the mains electricity supply 110 and the output from the control module 116.

During normal operation of the single-feed power supply system 100, the feed switch 210 remains closed under the control of the monitoring and operations module 200, whilst the internal bypass switch 212 is open. Accordingly, ‘unclean’ current received from the mains electricity supply 110 is passed through the rectifier 202, on to the battery configuration module 206 and out of the control module 116 to the battery module 118; ‘clean’ current from the battery module 118 is then received back into the control module 116 via the battery configuration module 206 and is passed through the inverter 204, before leaving the control module 116 to supply the load 112.

However, if the monitoring and operations module 200 detects problems with the mains electricity supply 110, it can open the feed switch 210 and alert the operator of the uninterruptible power supply device 114 to shut down the load 112 or effect transfer to an electricity generator. In the meantime, the load 112 continues to draw current from the battery module 118, gradually depleting the battery packs 124.

In addition to the above, if the monitoring and operations module 200 detects any operational difficulties with either the rectifier 202 or the inverter 204, it can close the bypass switch 212 and open the feed switch 210, such that current received from the mains electricity supply 110 flows directly out to the load 112, effectively bypassing processing by the control module 116. The bypass switch may also be closed by the monitoring and operations module 200 in response to manual operator input received via the display and input unit 122.

As mentioned earlier, loads 112 with different power requirements need to be supported by different models of the uninterruptible power supply device 114 of the present invention. Different models are provided for loads having power requirements up to: 700 VA; 1000 VA; 1500 VA; 2000 VA; 2500 VA; 3000 VA; 4000 VA; 5000 VA; and 6000 VA. Each model employs a control module 116 having rectifiers 202 and inverters 204 of different capacities and one of three battery configuration modules 206, with each battery configuration module 206 providing a different operating voltage. The electrical requirements dictating the choice of rectifier 202 and inverter 204 will be well understood by those skilled in the art and so are not discussed here. In contrast, the three different battery configuration modules 206 will presently be described in detail, since it is their configuration which enables substantially identical battery modules 118 to be used for every different model of the uninterruptible power supply device 114. However, prior to this, the battery modules 118 themselves will first be described.

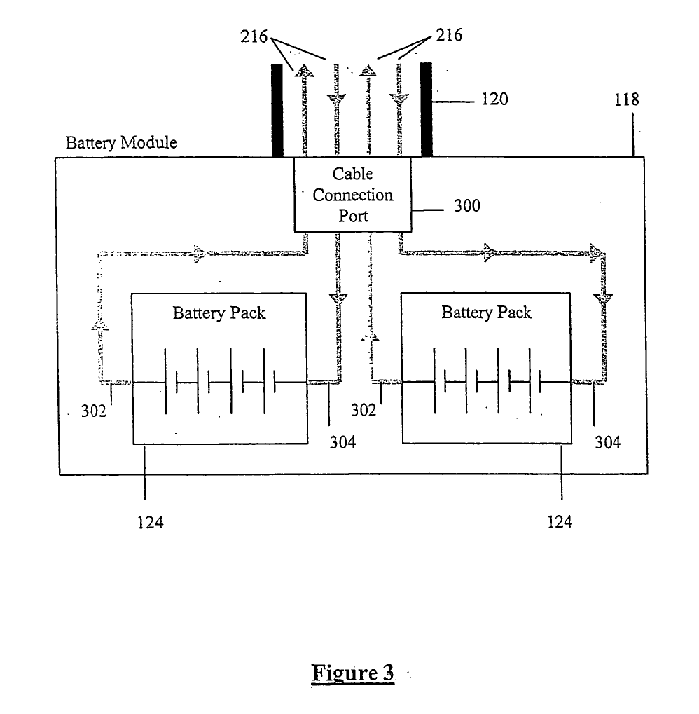

FIG. 3 shows the battery module 118 of FIG. 1, and for all other embodiments of the present invention, in more detail. The connecting cable 120 which links the battery module 118 to the control module 116, slots into a cable connection port 300. Each battery pack 124 within the battery module 118 is comprised of four 12 V cells which are connected in series, providing a voltage of 48 V. No connection between the battery packs 124 is made within the battery module 118. A terminal wire 302 from the positively charged terminal of each battery pack 124 and a terminal wire 304 from the negatively charged terminal of each battery pack are connected into the cable connection port 300, which connects each one of the four connecting wires 302, 304 to a unique one of the four connecting wires 216 of the connecting cable 120.

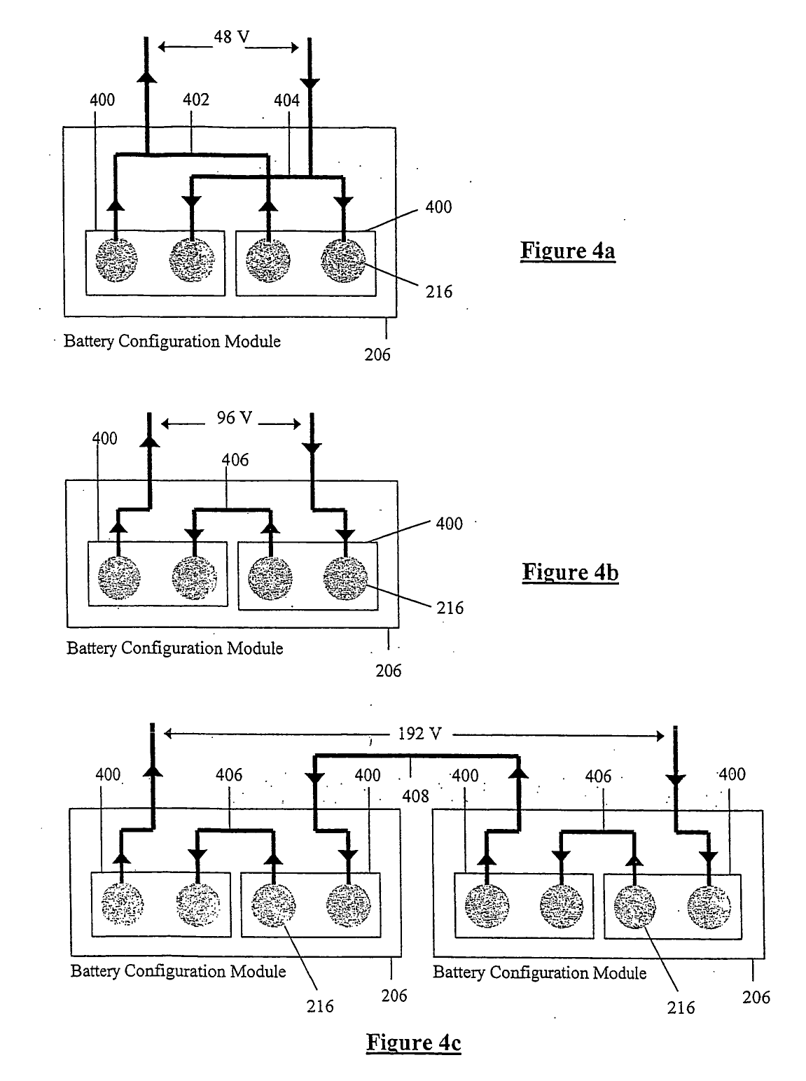

The three different battery configuration modules 206 to which the battery modules 118 may be connected, for all embodiments of the present invention, will now be described with reference to FIGS. 4a, 4b and 4c, which show how a series of different hard-wired connections made within the battery configuration module 206 provides three different operating voltages. In each case, the battery configuration module 206 within any model of the uninterruptible power supply device 114 is arranged to be externally connectable only to the connecting cable 120, to protect against an operator mistakenly inserting a cable of the wrong type and damaging the device. In addition, the battery configuration module 206 is arranged to accept the connecting cable 120 only when it is provided in a predetermined orientation.

FIG. 4a shows a battery configuration module 206, within a control module 116, arranged to connect the two 48 V battery packs 124 within a battery module 118 in parallel. When the connecting cable 120 is connected to the battery configuration module 206, the four connecting wires 216 plug into two sub-sockets 400, with each sub-socket 400 receiving the connecting wires from one of the battery packs 124. The two battery packs 124 are joined in parallel through hard-wired connections 402 and 404, which connect respectively the ‘positive’ and ‘negative’ terminals of the battery packs 124. Hence, as a result of the parallel connection, the voltage across the terminals of the battery configuration module is 48 V.

Manufacturers recommend that the maximum current draw from standard 12 V cells, such as those which may be employed in the battery packs 124, is 30 A. When determining the power supplied to a load 112 which works from alternating current, it is necessary to employ a power factor correction of ˜0.7 to calculate the equivalent power which would be required under direct current, such that the following equation for an equivalent load operating from direct current holds:
0.7 P=I V
where P is the power required by the device which operates from alternating current, I is the direct current and V is the direct voltage. Accordingly, a battery configuration module 206, configured as shown in FIG. 4a, can be used to support a load operating on alternating current which requires power up to 2000 VA. Hence, the battery configuration module 206 shown in FIG. 4a can be used in each of the 700 VA, 1000 VA, 1500 VA and 2000 VA models of the uninterruptible power supply device 114.

FIG. 4b shows a battery configuration module 206 arranged to connect the two 48 V battery packs within a battery module 118 in series. The series connection is achieved through the hard-wired connection 406, which connects the ‘positive’ terminal of one battery pack 124 to the ‘negative’ terminal of the other battery pack 124, with the remaining ‘negative’ battery pack terminal being hard-wired to the ‘negative’ terminal of the battery configuration module 206 and the remaining ‘positive’ battery pack terminal being hard-wired to the ‘positive’ terminal of the battery configuration module 206. Accordingly, the voltage across the terminals of the battery configuration module 206 when the battery packs 124 are connected in series is 96 V. Using the equation above, it can be seen that the battery configuration module 206 shown in FIG. 4b can be used in each of the 2500 VA, 3000 VA and 4000 VA models of the uninterruptible power supply device 114.

A still higher voltage can be achieved by connecting two battery modules 118 to a control module 116. Two of the 96 V battery configuration modules 206, shown in FIG. 4b, are incorporated into the control module 116, as shown in FIG. 4c. Each battery module 118 is connected by a separate connecting cable 120 to one of the battery configuration modules 206. The ‘positive’ terminal of one of the battery configuration modules 206 is connected to the ‘negative’ terminal of the other battery configuration module 206 by the hard-wired connection 408, thereby connecting the two battery configuration modules 206 in series. The remaining ‘positive’ and ‘negative’ terminals are hard-wired to the rectifier 202 and inverter 204, as previously described for a single battery configuration module in FIG. 2. Accordingly, the voltage provided when two of the 96 V battery configuration modules 206 are connected in series is 192 V. The battery configuration module 206, shown in FIG. 4c, can be used in the 5000 VA and 6000 VA models of the uninterruptible power supply device 114.

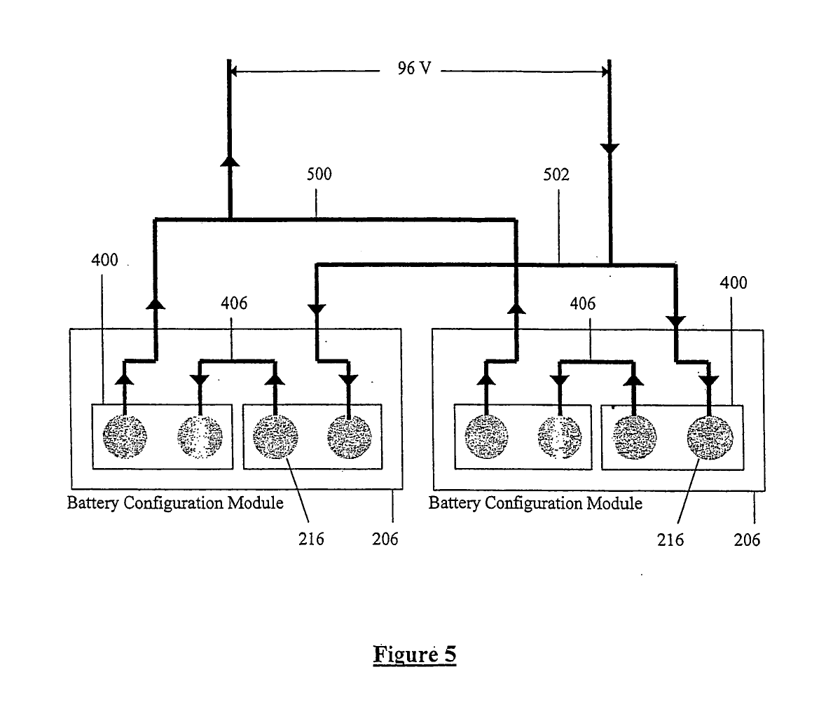

Incorporating additional battery configuration modules 206 within any of the control modules 116 of the different models of the uninterruptible power supply device 114, allows the run-time of the device to be extended, that is the time period over which the device is able to supply the load 112 in the event of failure of the mains electricity supply 110. This is achieved by replicating the particular arrangement of the battery configuration module 206 and the battery module 118 within a UPS model and then connecting the arrangements in parallel. FIG. 5 shows an example of this for the UPS models which use the 96 V arrangement of FIG. 4b. The control module 116 within the uninterruptible power supply device 114 is provided with two battery configuration modules 206 which are arranged according to FIG. 4b, with a separate battery module 118 connecting into each of the battery configuration modules 206. The two battery configuration modules 206 are connected in parallel by means of the hard-wired connections 500 and 502, which respectively connect their ‘positive’ and ‘negative’ terminals. In this way, the current required by the load 112 can be provided by the uninterruptible power supply device 114 for roughly twice as long.

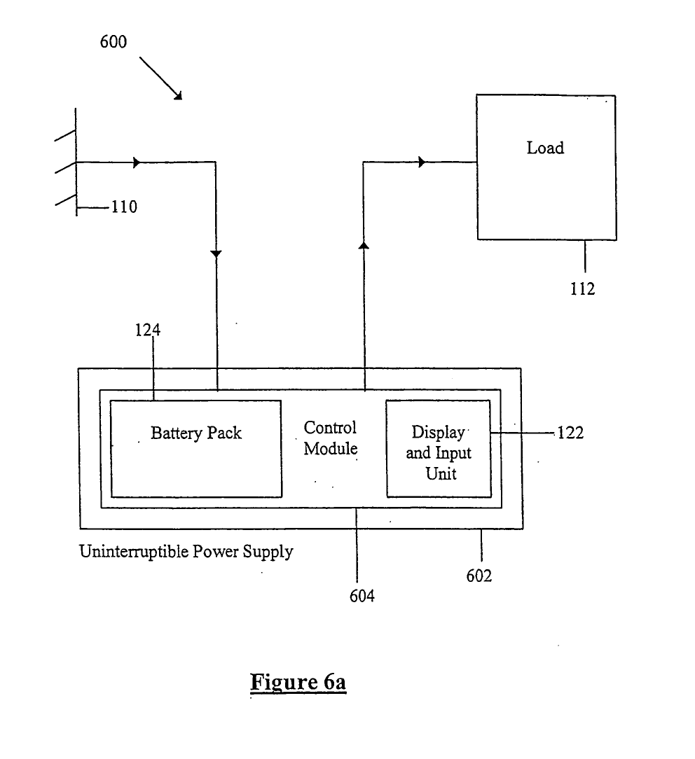

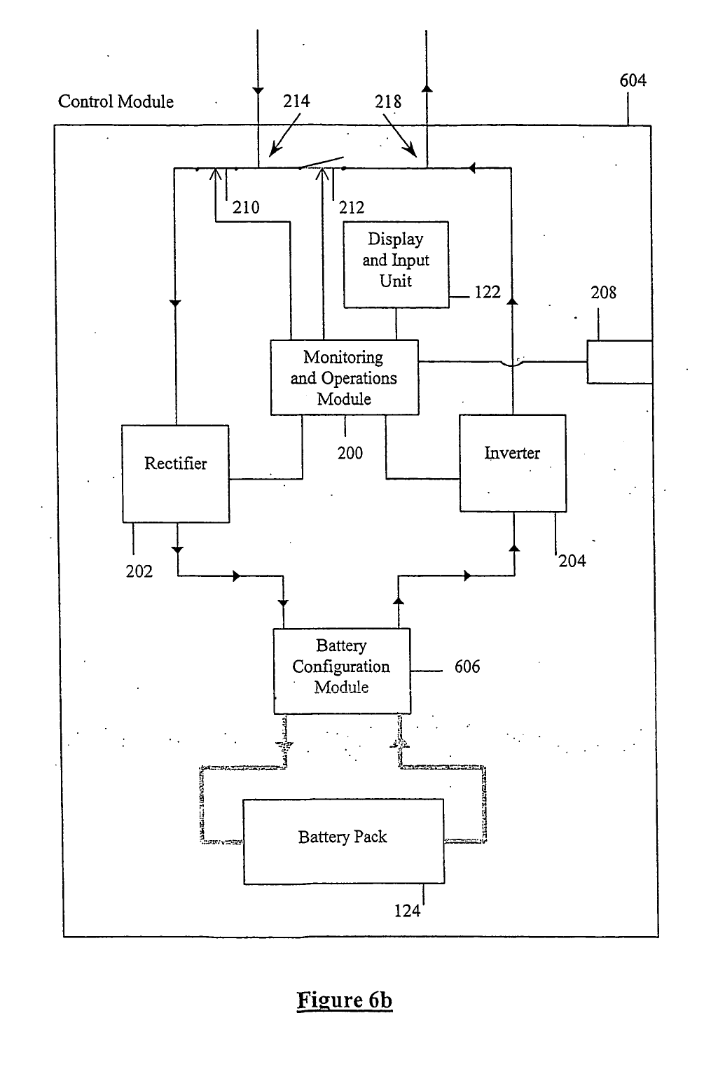

A second embodiment of the present invention will now be described with reference to FIGS. 6a and 6b. FIG. 6a shows a single-feed power supply system 600 similar to that shown in FIG. 1, but with the uninterruptible power supply device 114 of the first embodiment being replaced by the uninterruptible power supply device 602 of the second embodiment. The latter differs from the former in that it is only comprised of a control module 604 and does not feature a battery module 118 as in the first embodiment; instead a battery pack 124 is incorporated within the control module 604 itself.

The control module 604 of the second embodiment is shown in more detail in FIG. 6b. It is substantially identical to the control module 116 of the first embodiment except for its battery configuration module 606, which is hard-wired to the battery pack 124 provided internally to the control module 604. Accordingly, the voltage across the terminals of the battery configuration module 606 is 48 V, making the uninterruptible power supply device 602 of the second embodiment only suitable for use with loads 112 requiring 700 VA, 1000 VA, 1500 VA or 2000 VA of power.

Although the battery configuration module 606 is not provided as an external port of the control module 604, into which a battery module 118 can be connected, a battery configuration module 206 of the first embodiment, configured to provide a voltage of 48 V (as shown in FIG. 4a), can be incorporated into the control module 604. This enables a battery module 118 to be connected in parallel to the internal battery pack 124, thereby extending the run-time of the uninterruptible power supply device 602.

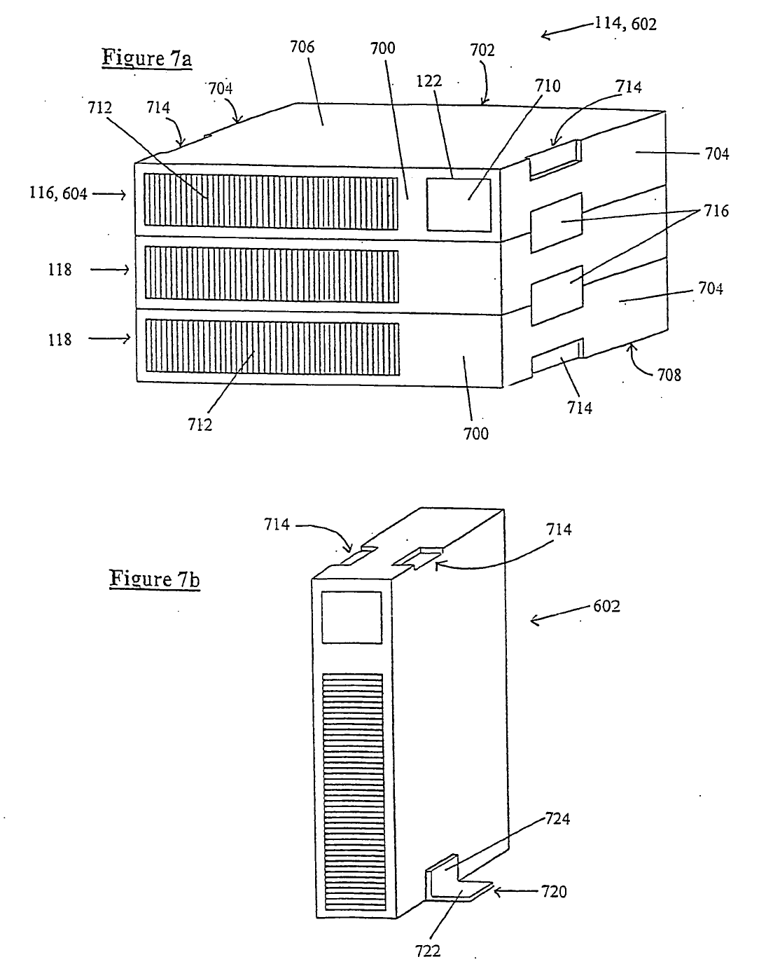

The physical form of the uninterruptible power supply devices of the present invention, when in rack-mount and standalone formations, will now be described with reference to FIGS. 7a and 7b. The uninterruptible power supply devices are modular, being formed from a control module unit and one or more battery module units, with the units talking the form of substantially rectangular casing boxes of approximately the same size. As mentioned earlier, the weight of the units is restricted to 25 kg, so that no one component of the uninterruptible power supply device is heavier than a single person lift. The side panels of each unit feature two oppositely facing shallow indentations at the top and bottom of each panel, such that when one unit is placed on top of another unit in rack-mount formation (horizontal orientation) a larger shallow indentation is formed, spanning across both units. This larger indentation can be bridged by a connecting plate, allowing the units to be secured together. The same indentation can be used to insert a foot support when the unit is switched to standalone format (vertical orientation).

FIG. 7a shows a perspective view of an uninterruptible power supply device 114, 602 of the present invention in rack-mount format (horizontal orientation). The uninterruptible power supply device 114, 602 shown in FIG. 7a is comprised of three units: a control module 116, 604 and two battery modules 118. The three units are stacked on top of one another, with the control module 116, 604 positioned on top of an upper battery module 118 and a lower battery module 118.

Each module is housed by a relatively slim and substantially rectangular casing box of approximately the same size. Each casing box has a front face 700, a rear face 702, two side faces 704, a top face 706 and a bottom face 708. The dimensions of the front and rear faces, 700 and 702, of the casing box conform with industry racking standards (height of almost 10 cm, width of almost 48 cm). The front face 700 of the control module 116, 604 incorporates the display and input unit 122, which has a substantially square front face 710, and a ventilation grill 712. The front face 700 of each battery module 118 also incorporates a ventilation grill 712.

Each side face 704 of a casing box is impressed part-way along its length with a shallow rectangular indentation 714, the indentation 714 being of uniform depth and aligned with the side face 704 on which it is made. The indentation 714 abuts the edge formed by the side face 704 and the top face 702 of the casing box; it extends part-way across the side face 704 but does not reach the mid-line of the face. The rectangular shallow indentation 714 is defined by four walls; three shallow walls determine the depth of the indentation and extend perpendicular to the side face 704 within the casing box, whilst the fourth wall lies within the casing box at the foot of these shallow walls and defines the base of the indentation 714. A mirror indentation 714 is located on the lower side of each side face 704, abutting the edge formed by the side face 704 and the bottom face 708 of the casing box. Hence, each side face 704 of a casing box features an upper indentation 714 and a lower indentation 714.

In FIG. 7a larger shallow indentations (not shown), or hollows, are formed (i) at the junction where the side faces 704 of the control module 116, 604 meet the corresponding side faces of the upper battery module 118 and (ii) at the junction where the side faces 704 of the upper battery module 118 meet the corresponding side faces of the lower battery module 118. Each of these larger shallow indentations is bridged by a rectangular connecting plate 716, which fits snugly into the hollow formed by two meeting indentations 714, making for a substantially flat side face of the uninterruptible power supply device 114, 602. The screw fixings by which the connecting plates 716 are screwed into the hollows are not shown.

When the uninterruptible power supply device 114, 602 of FIG. 7a is to be used in standalone format, it is rotated through 90°, such that the left-hand and right-hand sided faces 704 of the device in rack-mount format (horizontal orientation) are transposed to the bottom and top faces of the device in standalone format (vertical orientation). Hence, in standalone format the connecting plates 716 are located on the top face (and optionally bottom face) of the uninterruptible power supply device 114, 602.

However, in the second embodiment of the present invention the uninterruptible power supply device 602 can be formed by the control module 604 alone. In this case, the uninterruptible power supply device 602 must be stabilised at its base when used in standalone format (vertical orientation), as shown in FIG. 7b. Each indentation 714 located at the bottom of the device 602 can be used to insert a stabilising foot base 720 whose cross-section is of an inverted ‘T’ shape. The stabilising foot base 720 is comprised of a base platform 722 and an upright stem wall 724. The height of the base platform 722 is substantially the same as the depth of an indentation 714, such that the base platform 722 can be slotted into the indentation 714. The length of the base platform 722 is such that when in position underneath the uninterruptible power supply device 602, as shown in FIG. 7b, the stem wall 724 of the foot base 720 rests against the device's side wall. The foot bases 720 are made of sturdy material, such that when they are positioned either side of the uninterruptible power supply device 602, in standalone format, they act as supports and prevent the device from toppling over.

Of course, when an uninterruptible power supply device is changed from rack-mount to standalone format, the orientation of the device's display unit also changes, which can make the display difficult to read. The present invention addresses this by providing a display and input unit 122 whose orientation can be readily manually changed when the uninterruptible power supply device 114, 602 is switched between rack-mount and standalone formats.

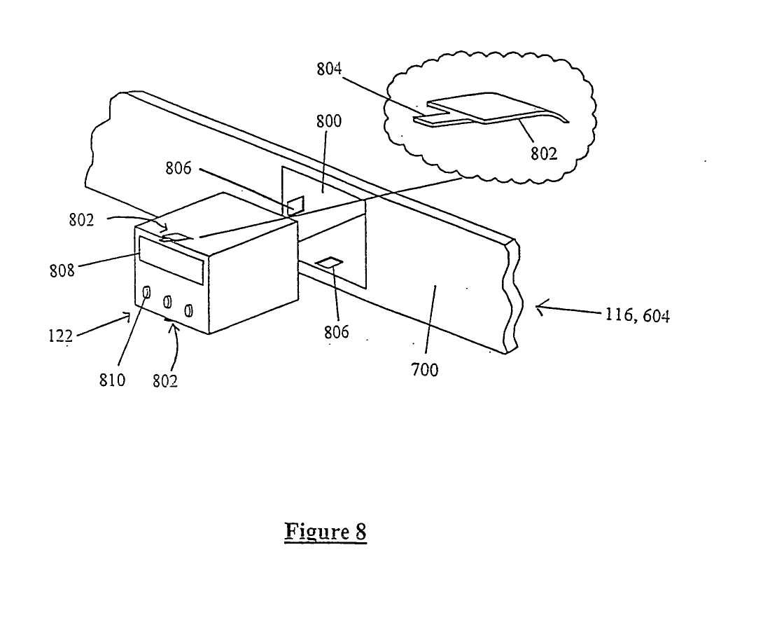

FIG. 8 shows a partial perspective view of a front panel of a control module 116, 604 with a disengaged display and input unit 122. In normal use the display and input unit 122 is housed inside a receptacle 800 within the control module 116, 604. The display and input unit 122 substantially takes the shape of a cube; it is connected to the monitoring and operations module 200 within the control module 116, 604 by a slack ribbon cable (not shown). The display and input unit 122 is provided with a pair of spring clips 802, with one spring clip 802 being located towards the front centre of each of the top and bottom faces of the cube. An enlarged view of one of the spring clips 802 is shown in FIG. 8. Each spring clip 802 is provided with an operator tab 804.

A series of four slots 806 are located near the entrance of the receptacle 800, with a single slot 806 positioned at the mid-length of each receptacle wall. Each slot 806 is arranged to receive a single spring clip 802, although only an oppositely facing pair of the slots will ever be engaged by the two spring clips 802 at any one time. In normal use, when housed within the receptacle 800, the display and input unit 122 is secured by the engagement of the spring clips 802 with the two slots 806 to which they are aligned. When an operator inserts the display and input unit 122 into the receptacle 800, the spring clips 802 are depressed by their contact with the receptacle's inside walls until they engage with the slots 806. Whilst the display and input unit 122 is housed within the receptacle 800, the operator tabs 804 protrude slightly from above and below the front face 710 of the display and input unit 122. This enables the display and input device 122 to be released from the receptacle 800 within the control module 116, 604 by depressing the protruding operator tabs 804.

Hence, when switching from a rack-mount format (horizontal orientation) to a standalone format (vertical orientation), the display and input unit 122 can be released from, and brought outside of, the receptacle 800, rotated through 90° and then re-inserted into the receptacle 800, so that it is in the correct orientation for the format of the uninterruptible power supply device. During this process, the display and input unit 122 remains connected to the control module 116, 604 at all times by means of the slack ribbon cable.

Under the present invention, the display and input unit 122 of the uninterruptible power supply device 114, 602 is provided with a liquid crystal display screen 808 and a series of operator input buttons 810 (of which three only are shown). The liquid crystal display screen 808 allows more sophisticated information to be shown to the operator of the device than in the prior art. For example, rather than only outputting a Boolean signal to indicate whether the mains electricity supply 110 is operational, the liquid crystal display screen 808 is additionally able to indicate the present operating voltage which is provided by the mains electricity supply 110. Such information can help an operator to become alerted to an impending problem with the mains electricity supply 110 before the problem fully develops.

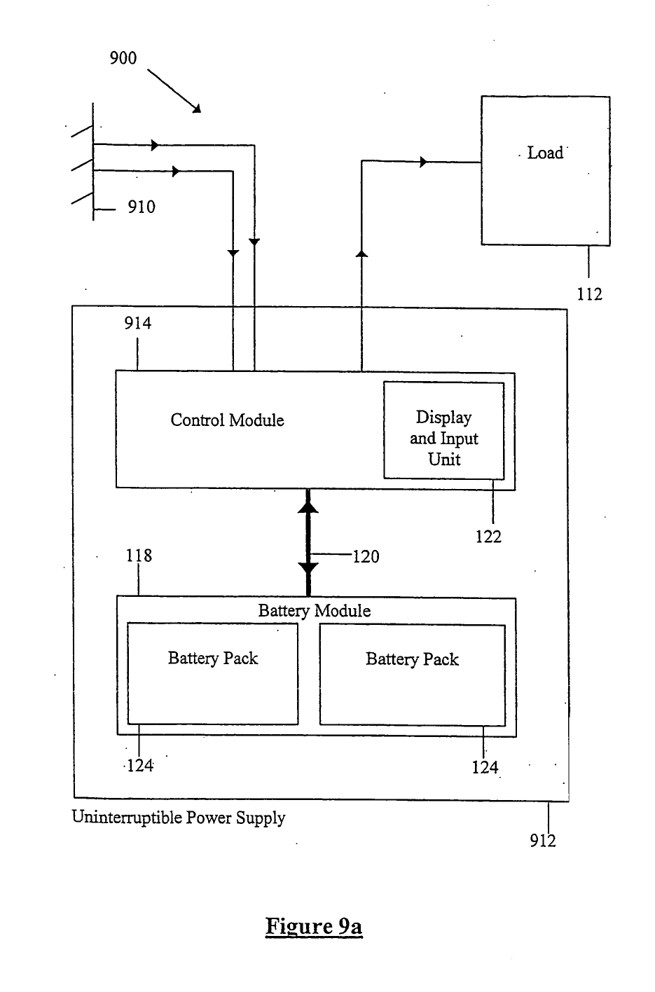

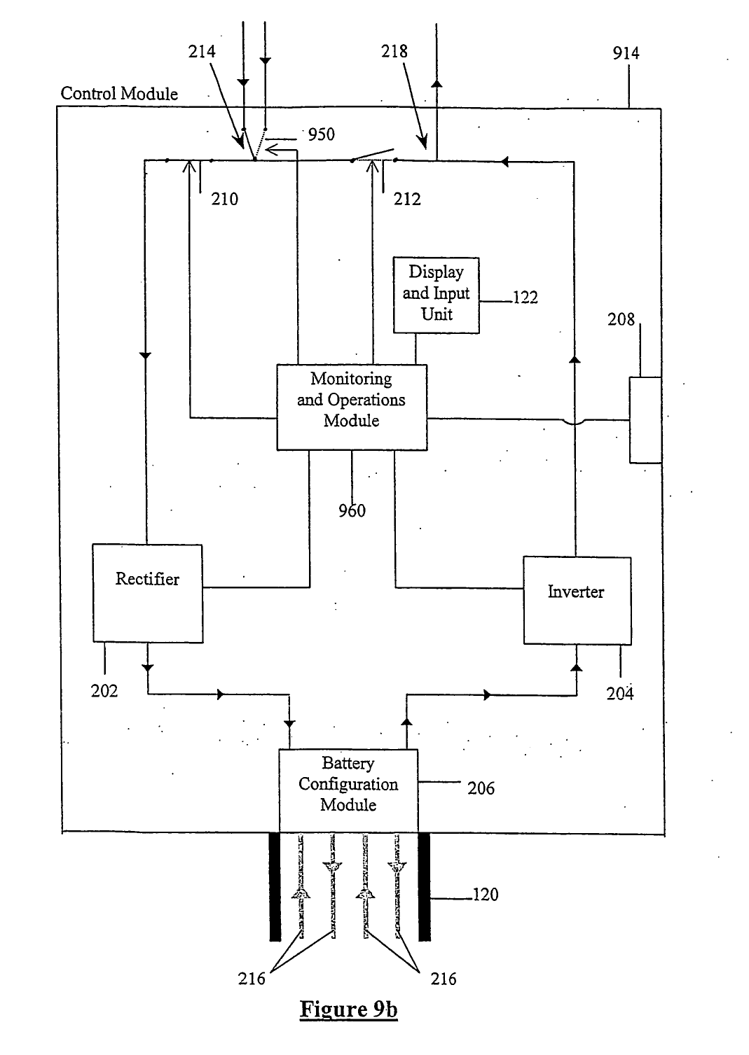

A third embodiment of the present invention will now be described with reference to FIGS. 9a and 9b. The third embodiment takes advantage of the three-phase electricity which is provided by power stations; three different alternating electric currents are generated and their phases are separated by 60° at the power station before all three currents are transmitted together as three-phase electricity to local distribution companies. Domestic users are provided with single-phase electricity, but industrial users can request to be supplied with electricity of single-phase, three-phase or multiple single-phases.

Although the third embodiment of the invention is presently described with respect to the first embodiment, it will be appreciated by those skilled in the art that it can readily be extended to the uninterruptible power supply device 602 of the second embodiment.

FIG. 9a shows a dual-feed power supply system 900 which is similar to the single-feed power supply system 100 of FIG. 1 in that a mains electricity supply 910 feeds a load 112 via an uninterruptible power supply device 912. However, the mains electricity supply 910 of the third embodiment is a dual-feed supply, whilst the mains electricity supply 110 of the first embodiment is not specified and could, for example, be single- or three-phase depending on the requirements of the load 112. The dual-feed mains electricity supply 910 provides two sources of single-phase electricity to the load 112, with the two sources operating at different phases from one another. In the event that one of the supplies fails, the load 112 can continue to operate using the second supply rather than running down the batteries of the uninterruptible power supply device 912 and requiring the load 112 to be shut down. The third embodiment of the present invention allows the load 112 to be maintained if a problem with the mains electricity supply 910 is restricted to only one of the single-phase supplies.

A different control module 914 from that of the first embodiment is required to process the dual-feed mains electricity supply 910. The control module 914 is shown in more detail in FIG. 9b. The key difference between the control module 914 of the third embodiment and the control module 116 of the first embodiment is that a bi-polar two-way switch 950, having two openings but a single gate, is inserted to at the input current junction 214. Both current supplies from the dual-feed mains electricity supply 910 are stopped short of the input current junction 214, with either one supply or the other being connectable to the input current junction 214 via the single gate.

Within the control module 914, a different monitoring and operations module 960 is required to control the bi-polar two-way switch 950. If the monitoring and operations module 960 detects a problem with the current from the first feed which is supplying the load 112, it can cause the bi-polar two-way switch 950 to deflect from the first current supply and connect to the second current supply. The uninterruptible power supply device 914 can then continue to operate normally and the batteries within the battery module 118 continue to be replenished. However, in the event that the monitoring and operations module 914 detects a problem with both current supplies provided by the dual-feed mains electricity supply 910, it disconnects from both supplies by opening both the feed switch 210 and the bi-polar two-way switch 950. The batteries of the battery module 118 continue to supply the load 112 for a short time, allowing emergency procedures to be undertaken by the operator of the uninterruptible power supply device 912, but the batteries are no longer replenished and must be replaced in due course.

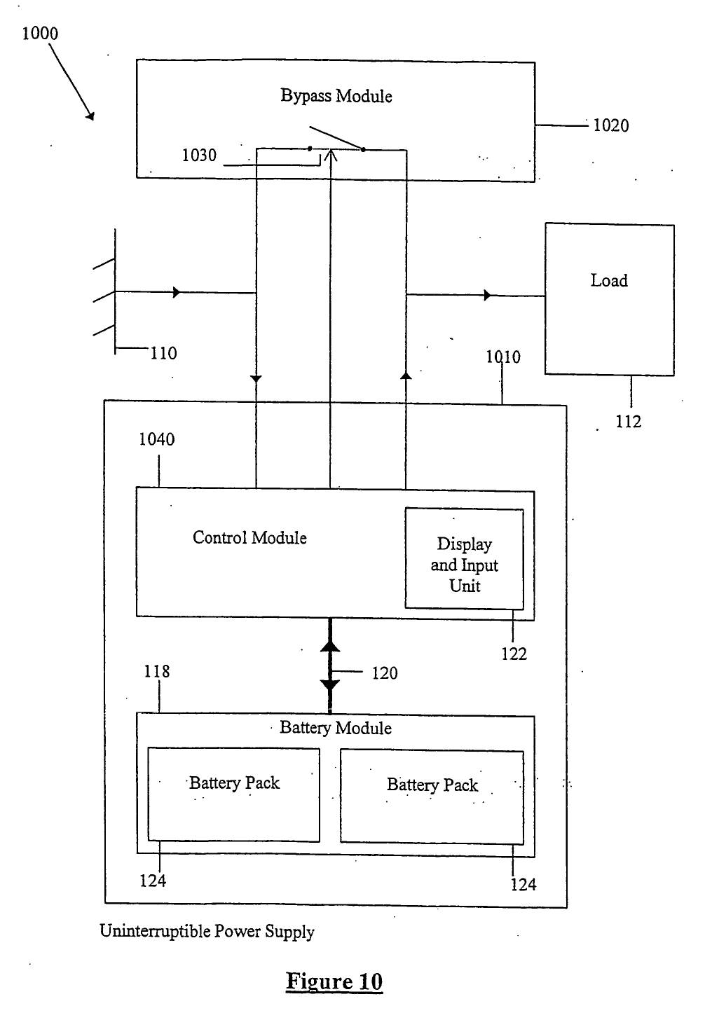

A fourth and final embodiment of the present invention will now be described with reference to FIG. 10. This embodiment is concerned with maintenance of uninterruptible power supply devices. When maintenance has to be carried out on a uninterruptible power supply device, the load it supports must be supplied directly by the mains electricity supply for the duration of the maintenance. Whilst in the previous embodiments the control modules 116, 604 and 914 are provided with an internal bypass switch 212, this is somewhat undesirable in that (i) the control module 116, 604 and 914 must remain connected to the load 112 at all times even though it is, in effect, being by-passed (maintenance to the control module 116, 604 and 914 must therefore be performed on-site) and (ii) closing the by-pass switch 212 momentarily connects the output of the inverter 204 to the mains electricity supply 110, 910 which, in some circumstances, can cause the inverter 204 to fail. The fourth embodiment of the present invention allows the entire uninterruptible power supply device to be isolated from the load 112.

FIG. 10 shows a maintenance system 1000 for an uninterruptible power supply device 1010 which is similar to the uninterruptible power supply device 114 of the first embodiment. It will be appreciated by those skilled in the art that the maintenance system 1000 can also be readily extended to uninterruptible power supply devices which are similar to those of the second and third embodiments. The uninterruptible power supply device 1010 is connected between the mains supply 110 and the load 112 in the usual manner. However, the mains electricity supply 110 and the load 112 are also connected to a bypass module 1020 which contains a maintenance switch 1030. The uninterruptible power supply device 1010 is provided with a control module 1040 which operates the maintenance switch 1030. The control module 1040 of this embodiment is substantially the same as the control module 116 of the first embodiment, except that its monitoring and operations module is additionally connected to, and configured to operate, the maintenance switch 1030. Accordingly, the control module 1040 is not shown in any further detail.

Referring back to the second problem (ii) outlined above, current variations in the mains electricity supply 110 can act against the output of the inverter and cause it to fail. In order to prevent the output of the inverter 204 being connected directly to the mains electricity supply 110, one of the operator input buttons 810 provided on the display and input unit 122 (see FIG. 8) is directly connected to the internal bypass switch 212 of the control module 1040. The operator must hit this button and cause an internal bypass within the control module 1040 in order for the control module 1010 to close maintenance switch 1030 and open the feed switch 210. In this way, the control module 1010 can be safely isolated from the load 112 and maintenance, such as the replacement of battery modules 118 and the rectifier 202, can be performed without undue damage being caused to the control module 1040.

Having described particular preferred embodiments of the present invention, it is to be appreciated that the embodiments in question are exemplary only, and that variations and modifications, such as those that will occur to those possessed of the appropriate knowledge and skills, may be made without departure from the spirit and scope of the invention as set forth in the appended claims. For example, the invention is also applicable to loads 112 whose main power supply is provided by an electric generator rather than the mains/utility supply 110, 910. The invention can also be readily adapted for loads 112 which are powered from direct current rather than alternating current. It will be appreciated that the configuration of the battery modules 118 can be readily modified, allowing different operating voltages to be achieved from the three hereinbefore described (48 V, 96V and 192 V). The dual-purpose indentations 714 on the control and battery pack modules can be of a variety of shapes and sizes and other forms of fastener, in addition to the connecting plates 716 hereinbefore described, can be used to secure the modules together. Similarly the foot support 720 may take on a variety of guises. Whilst a dual-position display and input unit 122 in the shape of a cube is presently preferred, the invention also extends to other shaped display units which are able to adopt a variety of positions within the same receptacle. In addition, the invention extends to a display unit which takes the form of a partially rotatable dial housing a liquid crystal display screen; a slack ribbon cable is again used to connect the display unit to the control module, but the unit need not be removed from the control module when changing between standalone and rack-mount formats, it need only be rotated. Finally, the forgoing description has assumed an inverter efficiency of 100% when calculating the different powered loads for which the battery configuration modules shown in FIGS. 4a, 4b and 4c can be employed, but in practice an efficiency of only 92% should be expected. Similarly, as a precautionary measure, the batteries within the battery modules should only be considered to provide 85% of their maximum.

1. An uninterruptible power supply device for supplying electrical energy to one of an array of loads having a broad range of power requirements, and for continuing to supply electrical energy to the said one load for a limited period of time in the event of failure of the said one load's main power supply, the uninterruptible power supply device including:
at least one power means for providing electrical energy for the said one load; and
control means, connected to the or each power means and the load, for controlling the device;
wherein:
the or each power means incorporates a plurality of electrical potential energy storage units, each storage unit providing substantially the same electrical potential energy as determined by a potential difference, or a voltage, across the electrical potential energy storage unit; and
the control means is arranged to connect the electrical potential energy storage units according to the power required by the load, the same power means being employable for each one of the array of loads.

2. An uninterruptible power supply device according to claim 1, wherein the electrical potential energy storage units within the or each power means are connected in parallel by the control means, making the voltage across the or each power means substantially the same as the voltage across the electrical potential energy storage units incorporated within the or each power means.

3. An uninterruptible power supply device according to claim 1, wherein the electrical potential energy storage units within the or each power means are connected in series by the control means, making the voltage across the or each power means substantially equal to the sum of the voltages across the electrical potential energy storage units incorporated within the or each power means.

4. An uninterruptible power supply device according to claim 1, wherein a voltage across the control means is determined by the voltage across the or each power means and the uninterruptible power supply device is arranged to provide electrical energy to a different one of the array of loads by altering the voltage across the control means.

5. An uninterruptible power supply device according to claim 4, wherein the voltage across the control means is suitable for supplying electrical energy to a sub-set of the array of loads, each load within the sub-set having a power requirement up to the power determined by the voltage across the control means.

6. An uninterruptible power supply device according to claim 4, wherein the uninterruptible power supply device contains a plurality of power means, the voltage across each power means being substantially the same, and the control means connects each one of the plurality of power means in parallel, making the voltage across the control means substantially the same as the voltage across each power means, thereby increasing the limited period of time for which the uninterruptible power supply device is able to supply the said one load in the event of failure of the said one load's main power supply.

7. An uninterruptible power supply device according to claim 4, wherein the uninterruptible power supply device contains a plurality of power means, the voltage across each power means being substantially the same, and the control means connects each one of the plurality of power means in series, making the voltage across the control means substantially equal to the sum of the voltages across each power means.

8. An uninterruptible power supply device according to claim 2, wherein the control means incorporates a single electrical potential energy storage unit, which the control means connects in parallel to the or each power means, making the voltage across the control means substantially the same as the voltage across the single potential energy storage unit.

9. An uninterruptible power supply device according to claim 1, wherein any connection made by the control means between electrical potential energy storage units, or between power means, is made within the control means.

10. An uninterruptible power supply device according to claim 1, wherein the or each power means weighs 25 kg or less.

11. An uninterruptible power supply device according to claim 1, wherein the control means weighs 25 kg or less.

12. An uninterruptible power supply device according to claim 1, wherein the electrical potential energy storage units are battery packs.

13. An uninterruptible power supply device according to claim 12, wherein each battery pack is comprised of four 12 V batteries which are connected in series.

14. An uninterruptible power supply device according to claim 1, further including at least one connecting cable for respectively connecting the control means to the or each power means, the or each connecting cable being connectable to the control means only in a preferred orientation.

15. An uninterruptible power supply device according to claim 1, wherein the control means is arranged to connect to a further power supply in the event of failure of the said one load's main power supply, such that the voltage across each potential energy storage unit remains substantially unchanged during normal operation of the uninterruptible power supply device.

16. An uninterruptible power supply device according to claim 15, wherein the main power supply and the further power supply are separate single-phase electricity supplies from the mains supply.

17. An uninterruptible power supply device according to claim 1, wherein the control means is provided with, and controls, an internal bypass switch which, when closed, causes the electrical energy as supplied by the load's main power supply to be provided directly to the load.

18. An uninterruptible power supply device according to claim 17, wherein the internal bypass switch is also manually operable by an operator of the uninterruptible power supply device.

19. An uninterruptible power supply device according to claim 18, wherein the uninterruptible power supply device is connectable to a bypass means, the bypass means being arranged to isolate the uninterruptible power supply device from the load after the internal bypass switch has been closed.

20. An uninterruptible power supply device according to claim 1, wherein the uninterruptible power supply device is configurable into one of two formats, namely a rack-mount format or a standalone format.

21. An uninterruptible power supply device according to claim 1, wherein the array of loads have power requirements ranging up to and including 6000 VA.

22. An uninterruptible power supply device according to claim 1, wherein the control means incorporates a display unit, housed within a receptacle, which is able to adopt a variety of positions within the receptacle.

23. An uninterruptible power supply device according to claim 22, wherein the display unit incorporates a liquid crystal display screen.

24. An uninterruptible power supply device according to claim 22, wherein the display unit takes substantially the shape of a cube which is readily removable from, and reinsertable into, the receptacle.

25. An uninterruptible power supply device according to claim 1, wherein:
the uninterruptible power supply device is configurable into both rack-mount and standalone formats and is formed from a plurality of modular units; and
the modular units are connectable together by bridging indentations of a first size which are formed between the modular units when positioned together in either rack-mount or standalone format.

26. An uninterruptible power supply device according to claim 25, wherein two oppositely facing panels of each modular unit feature two oppositely facing indentations of a second size at the top and bottom of the panel, the indentations of the second size being substantially half the size of the indentations of the first size.

27. An uninterruptible power supply device according to claim 26, wherein the indentations of the second size are dual-purpose, being also suitable for use as a receptacle for a foot support to stabilise a modular unit when used in the standalone format.

28. An uninterruptible power supply device for supplying electrical energy to a load, and for continuing to supply electrical energy to the load for a limited period of time in the event of failure of the load's main power supply, the uninterruptible power supply device including:
at least one power means for providing electrical energy for the load; and
control means, connected to the power means and the load, for controlling the device;
wherein the control means incorporates a display unit, housed within a receptacle, which is able to adopt a variety of positions within the receptacle.

29. (canceled)

30. (canceled)

31. (canceled)

32. (canceled)

33. (canceled)

34. (canceled)

35. (canceled)

36. (canceled)

37. (canceled)

38. An uninterruptible power supply device according to claim 28, wherein the display unit incorporates a liquid crystal display screen.

39. An uninterruptible power supply device according to claim 28, wherein the display unit takes substantially the shape of a cube which is readily removable from, and reinsertable into, the receptacle.

40. An uninterruptible power supply device for supplying electrical energy to a load, and for continuing to supply electrical energy to the load for a limited period of time in the event of failure of the load's main power supply, wherein:
the uninterruptible power supply device is configurable into both rack-mount and standalone formats and is formed from a plurality of modular units; and
the modular units are connectable together by bridging indentations of a first size which are formed between the modular units when positioned together in either rack-mount or standalone format.

41. An uninterruptible power supply device according to claim 40, wherein two oppositely facing panels of each modular unit feature two oppositely facing indentations of a second size at the top and bottom of the panel, the indentations of the second size being substantially half the size of the indentations of the first size.

42. An uninterruptible power supply device according to claim 41, wherein the indentations of the second size are dual-purpose, being also suitable for use as a receptacle for a foot support to stabilise a modular unit when used in the standalone format.

43. An uninterruptible power supply device according to claim 6, wherein the control means incorporates a single electrical potential energy storage unit, which the control means connects in parallel to the or each power means, making the voltage across the control means substantially the same as the voltage across the single potential energy storage unit.

44. An uninterruptible power supply device according to claim 8, wherein any connection made by the control means between electrical potential energy storage units, or between power means, is made within the control means.

45. An uninterruptible power supply device according to claim 8, wherein the control means weighs 25 kg or less.

46. An uninterruptible power supply device according to claim 8, wherein the electrical potential energy storage unit is a battery pack.

47. An uninterruptible power supply device according to claim 46, wherein the battery pack is comprised of four 12 V batteries which are connected in series.

48. An uninterruptible power supply device according to claim 8, wherein the control means is arranged to connect to a further power supply in the event of failure of the said one load's main power supply, such that the voltage across each potential energy storage unit remains substantially unchanged during normal operation of the uninterruptible power supply device.

49. An uninterruptible power supply device according to claim 8, wherein the control means is provided with, and controls, an internal bypass switch which, when closed, causes the electrical energy as supplied by the load's main power supply to be provided directly to the load.

50. An uninterruptible power supply device according to claim 8, wherein the uninterruptible power supply device is configurable into one of two formats, namely a rack-mount format or a standalone format.

51. An uninterruptible power supply device according to claim 8, wherein the array of loads have power requirements ranging up to and including 2000 VA.

52. An uninterruptible power supply device for supplying electrical energy to one of an array of loads having a broad range of power requirements, and for continuing to supply electrical energy to the said one load for a limited period of time in the event of failure of the said one load's main power supply, the uninterruptible power supply device including:
a plurality of electrical potential energy storage units for providing electrical energy for the said one load; and
a potential energy supply facilitator, connected to the plurality of electrical potential energy storage units and the load, for controlling the device;
wherein:
each storage unit provides substantially the same electrical potential energy as determined by a potential difference, or a voltage, across the electrical potential energy storage unit; and
the potential energy supply facilitator is arranged to connect the electrical potential energy storage units according to the power required by the load, the same plurality of potential energy storage units being employable for each one of the array of loads.

53. An uninterruptible power supply device for supplying electrical energy to a load, and for continuing to supply electrical energy to the load for a limited period of time in the event of failure of the load's main power supply, the uninterruptible power supply device including:
a plurality of potential energy storage units for providing electrical energy for the load; and
a potential energy supply facilitator, connected to the plurality of potential energy storage units and the load, for controlling the device;
wherein the potential energy supply facilitator incorporates a display unit, housed within a receptacle, which is able to adopt a variety of positions within the receptacle.

54. All methods of operating the uninterruptible power supply device, and or supplying electrical energy to at least one of an array of loads having a broad range of power requirements, as disclosed in the specification and or described with reference to any of the FIGS. 1 to 10 of the accompanying drawings.
